(19) United States
(12) Patent Application Publication
(10) Pub. No.: US 2006/0117703 A1
(43) Pub. Date: Jun. 8, 2006

(54) Window frame element produced by injection

(76) Inventor: Norbert Grov, Schortens (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/541,538

(22) PCT Filed: Dec. 30, 2003
(86) PCT No.: PCT/DE03/04257

§ 371 Date: Jul. 8, 2005

(30) Foreign Application Priority Data
Jan. 13, 2003 (DE) 10301042.4

(51) Int. Cl. E04C 2/38

(52) U.S. Cl. 52/716.8

(57) ABSTRACT

The invention relates to a window frame element produced by injection associated with shaping defining a main moulding direction for the parts of a hollow mould. The inventive window frame element comprises an U-shaped open guiding element (8) which is essentially perpendicularly to the direction of the main moulding and is embodied in such a way that the branches thereof clamp the edge of a displaceable glass on both sides thereof along the window frame element. The inventive guiding element (8) consists of the segments (9, 10) of two alternating branches which are shaped in one piece on the window frame element during injection. Said invention makes it possible to avoid separate production of a guiding element and mounting thereof on the window frame element.

The invention relates to a window frame element produced by diecasting with a shaping defining a main demolding direction for casting mold parts, and provided with a U-shaped guide which is open essentially perpendicularly with respect to the main demolding direction and is positioned by means of its limbs for grasping an edge of a window pane, which can be displaced along the window frame part, on both sides.

Window frame elements of this type are, for example, parts of car doors. For weight reasons, they are produced from light metal, in particular aluminum, and, for stability reasons, have a ribbed structure which defines a main demolding direction for the casting mold halves perpendicularly with respect to the area defined by the vehicle door. In the case of a vehicle door, the ribs are therefore directed toward the vehicle interior and vehicle exterior. As is known, vehicle doors have at head height window openings in which window panes are guided in a manner such that they can be cranked downward. The window frame elements are therefore provided with guides which are fastened as a U-shaped rail to the window frame element produced by diecasting. The rail is provided in a known manner with an inner cushion on which the edge of the window pane can slide.

Producing the U-shaped rail during the diecasting of the window frame element would require the use of a casting mold which, in addition to the casting mold halves, includes a slide with which the intermediate space between the limbs of the U-shaped rail is ensured, since this intermediate space cannot be filled by the casting mold parts moveable in the main demolding direction because the intermediate space between the limbs, as viewed in the main demolding direction, constitutes an undercut. However, the production and the use of such a complicated casting mold is not economical, with the result that in practice the U-shaped guide is produced separately and is subsequently fastened to the window frame element. This gives rise to an unsatisfactory outlay on installation.

The present invention is based on the problem definition of designing a window frame element of the type mentioned at the beginning in such a manner that more efficient manufacturing with lower manufacturing costs is possible.

To solve this problem, a window frame element of the type mentioned at the beginning is characterized, according to the invention, in that the guide is formed from sections of the two limbs that are arranged in an alternating manner and are molded integrally onto the window frame element during the diecasting.

For the window frame element according to the invention, the hitherto customary guide rail of continuous design is omitted and the guide is designed in such a manner that it is composed of guide sections arranged in an alternating manner on the one and on the other side of the window pane. The guide is therefore not designed as a U in cross section but rather is in each case of L-shaped design with the base of the guide groove, with the mutually consecutive L-sections being arranged in each case in a mirror-inverted manner with respect to one another, with the result that the one side and the other side of the edge of the window pane is guided in an alternating manner by successive sections.

This design of the guide makes it possible for the sections of the guide to be formed in a simple and economical manner during the diecasting of the window frame element, since the sections are produced by the casting mold parts which are moveable in the main demolding direction. The separating plane between the two casting mold parts is of correspondingly meandering design in order to form the cavities for the mutually consecutive sections of the guide.

In order to facilitate the demolding of the casting mold parts, it is advantageous if the sections that are arranged in an alternating manner have narrow side edges which are aligned with each other on a straight line, the narrow side edges preferably bounding a conical intermediate space between two sections of a limb. This makes it possible to design the separating plane, which is of meandering design, with conical meanders which permit easy demolding. In this case, the angle of conicity is preferably between 10° and 55°, more preferably between 30°, and 40° and particularly preferably 35°±2°.

The window frame element according to the invention can be particularly advantageously designed as an “A-pillar” of a vehicle door, i.e. as that frame part of the vehicle door which is adjacent to the A-pillar of the vehicle body. In the same manner, the rear door, which is of essentially mirror-inverted design, can be formed with a window frame element according to the invention adjacent to the C-pillar.

The invention is to be explained in more detail below with reference to an exemplary embodiment which is illustrated in the drawing, in which:

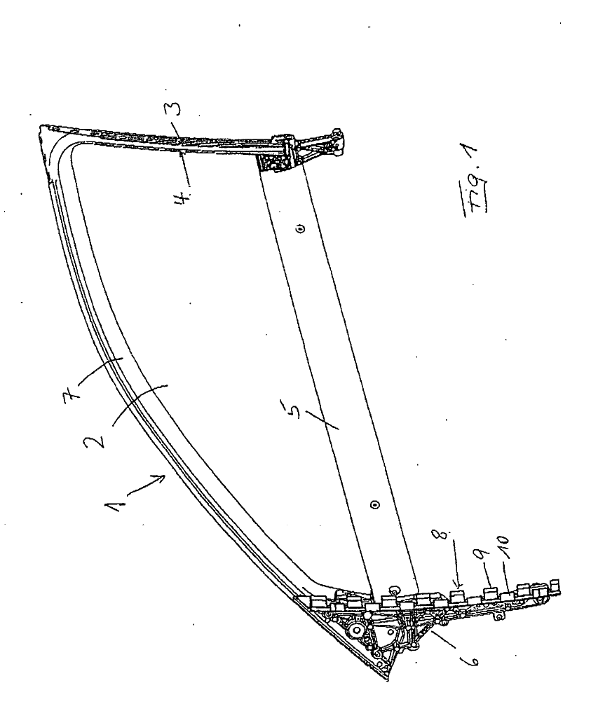

FIG. 1 shows a view with a window frame element according to the invention in the form of an A-pillar

FIG. 2 shows a simplified side view of the window frame element

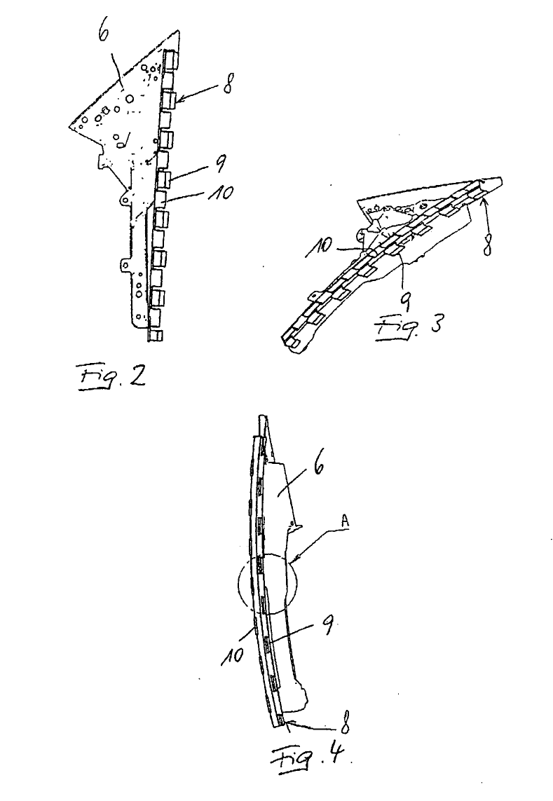

FIG. 3 shows a perspective view in particular of the guide of the window frame element

FIG. 4 shows a plan view of the guide of the window frame element

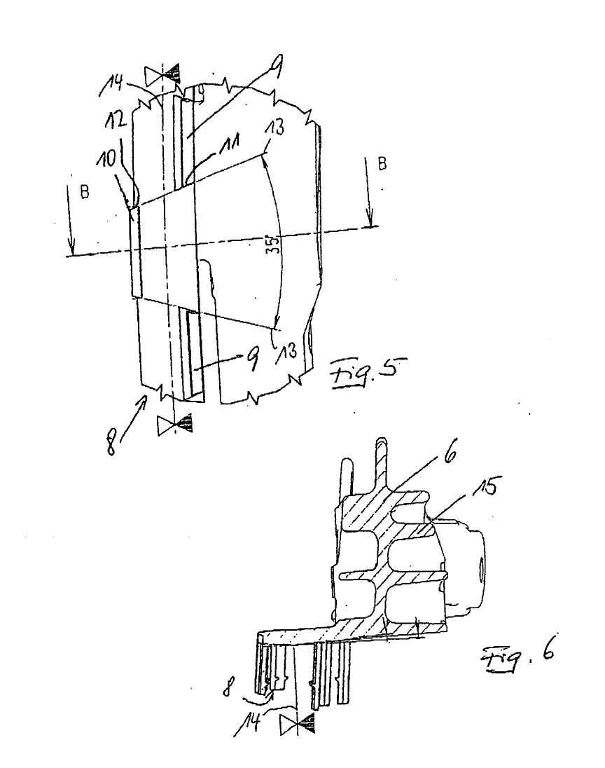

FIG. 5 shows a detail A of the illustration according to FIG. 4

FIG. 6 shows a section along the section line B-B in FIG. 5.

FIG. 1 shows a vehicle door 1 which has a window opening 2. The window opening is bounded on its rear side by a B-pillar 3 which is provided with a rear window guide 4. A lateral strut 5 bounds the lower edge of the window opening 2 and connects the B-pillar 3 to a front post 6 which constitutes the A-pillar of the vehicle door 1. An upper boundary of the window opening 2 is realized by a curved profiled component 7.

The pillar 6 is provided with a guide 8 which is open toward the window opening 2 and is formed by sections 9, 10 that are fitted in an alternating manner. The guide 8 extends until under the window opening 2, since the window pane covering the window opening can be moved downward in the conventional manner and has to continue to be guided when moving down into the door region below the window opening 2.

FIGS. 2 to 4 illustrate the post 6 with the guide 8 formed by the sections 9, 10 that are fitted in an alternating manner.

The detail illustrated in FIG. 5 shows two sections 9 of a limb of the guide and a section 10, which is situated in between, of the other limb of the guide 8. It is clear here that the sections 9, 10 are provided with narrow side edges 11, 12 which lie on a straight line 13. In this case, two straight lines 13 bound an intermediate space between two sections 9, which space is of conical design and has an angle of conicity of 35°. The conical design of the intermediate space necessitates a corresponding conical design of the meandering shape of the casting mold parts, the separating plane 14 of which is shown outside the meandering shape in FIGS. 5 and 6. The conical design of the meandering shape considerably facilitates the demolding.

FIG. 6 shows that the post 6 has ribs 15 which define the demolding direction (perpendicular with respect to the separating plane 14) of the casting mold parts, since they have to point in the main demolding direction. FIG. 6 shows that the guide 8 forms an angle with the main demolding direction and is essentially perpendicular with respect to the main demolding direction. The guide 8 can nevertheless be cast with the aid of the casting mold parts, which can be moved in the main demolding direction, because the sections 9, 10 are arranged in an alternating manner perpendicular with respect to the main demolding direction and permit a meandering part of the casting mold part, which part can be moved along the straight lines 13, to move in and out.

The guide 8, which is not of continuous design according to the invention, does not impair the operating capability, since the sections 9, 10 ensure sufficient stability for the guide 8 on both sides of the edge of the window pane.

The fixing of the guide 8 during the diecasting of the post 6 without the casting mold needing to be complicated for this purpose by means of slides or similar saves the hitherto required installation work on fitting a separately produced guide rail to the post 6.

1. A window frame element produced by diecasting with a shaping defining a main demolding direction for casting mold parts, and provided with a U-shaped guide (8) which is open essentially perpendicularly with respect to the main demolding direction and is positioned by means of its limbs for grasping an edge of a window pane, which can be displaced along the window frame part, on both sides, characterized in that the guide (8) is formed from sections (9, 10) of the two limbs that are arranged in an alternating manner and are molded integrally onto the window frame element during the diecasting.

2. The window frame element as claimed in claim 1, characterized in that it forms a post (6) which is provided with ribs {15) pointing in the main demolding direction.

3. The window frame element as claimed in claim 1, characterized in that the sections (9, 10) that are arranged in an alternating manner have narrow side edges (11, 12) which are aligned with each other on a straight line (13).

4. The window frame element as claimed in claim 3, characterized in that the narrow side edges (11, 12) bound a conical intermediate space between two sections (9; 10) of a limb.

5. The window frame element as claimed in claim 4, characterized in that the angle of conicity is between 10° and 45°.

6. The window frame element as claimed in claim 5, characterized in that the angle of conicity is between 30° and 40°.

7. The window frame element as claimed in claim 6, characterized in that the angle of conicity is 35° 2°.

8. The window frame element as claimed in claim 1, characterized in that it is designed as an A-pillar or C-pillar of a car door (1).
